(19) United States
(12) Patent Application Publication
(10) Pub. No.: US 2005/0055252 A1
(43) Pub. Date: Mar. 10, 2005

(54) Method and system for online interactive appointments and reservations

(76) Inventor: Robert P. Todd, Duluth, GA (US)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(21) Appl. No.: 09/733,112

(22) Filed: Dec. 8, 2000

Related U.S. Application Data
(60) Provisional application No. 60/170,100, filed on Dec. 10, 1999.

(51) Int. Cl. G06F 17/60

(52) U.S. Cl. 705/5

(57) ABSTRACT

A method and system accessible over a computer network, such as the Internet, by which clients can access and reserve an appointment date and time with a particular service provider is disclosed. The method enables the client to search for the particular service provider from a database of available service providers using a plurality of desired criteria, such as location and type of service provided by the particular service provider. The client can either request a proposed appointment date and time from all available dates and times or select from a list of available dates and times associated with the particular service provider. If the proposed dates and times are not available, alternate proposed dates and times are suggested, or the client can request a new proposed appointment date and time on his own. If available, the proposed date and time is confirmed once the client provides identifying information about himself. The confirmed appointment date and time can be cancelled by either the client or the particular service provider.

### CROSS-REFERENCE TO RELATED APPLICATION

This application claims the benefit of U.S. Provisional Application No. 60/170,100, filed Dec. 10, 1999, and entitled “Method and System for Online Interactive Appointments and Reservations.”

### NOTICE OF COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### REFERENCE TO COMPUTER PROGRAM SUBMITTED ON CD

This application incorporates by reference the computer program listing appendix submitted on one (1) CD-ROM entitled “Robert P. Todd Computer Program Listing” with the filing of this application, in accordance with 37 C.F.R. § 1.52(e). Pursuant to 37 C.F.R. § 1.77(b)(4), the material on said CD-ROM is incorporated by reference herein, said material being identified as follows:

| DATE OF | SIZE | |
|---|---|---|
| CREATION | IN BYTES | FILE NAME |
| 12/08/2000 | 24,014 | AddEmployee.txt |
| 12/08/2000 | 512 | Appointment.txt |
| 12/08/2000 | 3,529 | Appts.txt |
| 12/08/2000 | 3,504 | BusinessLogin.txt |
| 12/08/2000 | 10,388 | BusinessMemberhtml.txt |
| 12/08/2000 | 32,913 | BusinessMember.txt |
| 12/08/2000 | 10,317 | BusinessLoginhtml.txt |
| 12/08/2000 | 17,139 | BusinessMemberLoggedIn.txt |
| 12/08/2000 | 30,035 | BusinessMemberLogin.txt |
| 12/08/2000 | 23,174 | BusinessMemberUpdate.txt |
| 12/08/2000 | 14,884 | BusinessRegistrationhtml.txt |
| 12/08/2000 | 1,806 | CommObject.txt |
| 12/08/2000 | 3,195 | DailyView.txt |
| 12/08/2000 | 12,680 | DataBaseManager.txt |
| 12/08/2000 | 4,715 | CheckAvail.txt |
| 12/08/2000 | 11,878 | FAQhtml.txt |
| 12/08/2000 | 24,865 | indexhtml.txt |
| 12/08/2000 | 1,553 | loadtables.txt |
| 12/08/2000 | 17,415 | NewBusinessLogin.txt |
| 12/08/2000 | 1,007 | ProcessPage.txt |
| 12/08/2000 | 4,496 | Memberhtml.txt |
| 12/08/2000 | 7,290 | Reservation-Comboboxhtml.txt |
| 12/08/2000 | 3,256 | ReservationServlet.txt |
| 12/08/2000 | 13,858 | RTHeaderFooter.txt |
| 12/08/2000 | 3,019 | ScheduleApp.txt |
| 12/08/2000 | 2,450 | SpecialtyServlet.txt |
| 12/08/2000 | 547 | ScheduleRow.txt |
| 12/08/2000 | 364 | Schhtml.txt |
| 12/08/2000 | 3,826 | Reserve.txt |

### FIELD OF THE INVENTION

The present invention relates broadly to information processing and, more particularly, to a computerized method and system for enabling a consumer/client to access a retailer/service provider's appointment calendar to reserve available appointment times.

The “date of creation” listed above of the files is the date on which such files were created for purposes of inclusion on the CD-ROM; the date is NOT the date on which the contents of such files were created.

### BACKGROUND OF THE INVENTION

Computerized systems within a single organization that enable one individual within the organization to view another individual's calendar and to request meetings with that individual on specific days and times are known in the art. In addition, some hotels have reservation schedules available over the Internet that allow potential customers to determine room availability and to make reservations for particular rooms on particular days by providing contact and credit card information.

There currently is a need, however, for a computerized system accessible over a computer network, such as the Internet, by which customers or clients (hereinafter referred to as “clients”) can search for available retailers or service providers (hereinafter referred to as “service providers”) in a particular geographic region, view a particular service provider's calendar of appointments, and then make a reservation or schedule an appointment with that service provider at an available date and time by providing contact and credit card, or comparable, information.

### BRIEF SUMMARY OF THE PRESENT INVENTION

Briefly described, the present invention includes, in a computerized system, a method of enabling a client to schedule an appointment with a particular service provider, including the steps of providing a database of service providers, each service provider having associated therewith a plurality of identifying criteria, receiving from the client a search request having a plurality of desired criteria associated with the particular service provider, comparing the plurality of desired criteria with the plurality of identifying criteria for each service provider in the database of service providers, presenting the client with a list of service providers having associated therewith the desired criteria, enabling the client to select the particular service provider from the list of service providers presented, enabling the client to request a proposed appointment date and time for meeting with the particular service provider, comparing the proposed appointment date and time with a database of available dates and times associated with the particular service provider, obtaining identifying information from the client, converting the proposed appointment date and time to a confirmed appointment date and time, adding the confirmed appointment date and time to a database of appointments associated with the particular service provider, and removing the confirmed appointment date and time from the database of available dates and times associated with the particular service provider.

The method may further include the step of providing the client with directions to the particular service provider and the step of sending the client a reminder of the confirmed appointment date and time prior to the confirmed appointment date and time. Additionally, the method may include the step of, if the proposed appointment date and time for meeting with the particular service provider is not available, suggesting a different appointment date and time that is available in the database of available dates and times associated with the particular service provider. Alternatively, the method may include the step of, if the proposed appointment date and time for meeting with the particular service provider is not available, enabling the client to request another proposed appointment date and time. The method further may include the step of enabling the client to define the search request by selecting each of the desired criteria from a database of available desired criteria.

Additionally, the method may further include the step of enabling the client to view information about the confirmed appointment date and time and the step of enabling the client to view information about confirmed appointment dates and times for a plurality of particular service providers. Likewise, the method may also include the step of enabling the particular service provider to view information about the confirmed appointment date and time and the step of enabling the particular service provider to view information about confirmed appointment dates and times for a plurality of clients.

The method of the present invention may further include the steps of enabling the client or service provider to cancel the confirmed appointment date and time, adding the confirmed appointment date and time to the database of available dates and times associated with the particular service provider, and removing the confirmed appointment date and time from the database of appointments associated with the particular service provider.

In another preferred embodiment, the present invention includes, in a computerized system, a method of enabling a client to schedule an appointment with a particular service provider, including the steps of providing a database of service providers, each service provider having associated therewith a plurality of identifying criteria, obtaining identifying information from the client. receiving from the client a search request having a plurality of desired criteria associated with the particular service provider, comparing the plurality of desired criteria with the plurality of identifying criteria for each service provider in the database of service providers, presenting the client with a list of service providers having associated therewith the desired criteria, enabling the client to select the particular service provider from the list of service providers presented, enabling the client to request a proposed appointment date and time for meeting with the particular service provider from a selection of available appointment dates and times from the database of available dates and times associated with the particular service provider, converting the proposed appointment date and time to a confirmed appointment date and time, adding the confirmed appointment date and time to a database of appointments associated with the particular service provider, and removing the confirmed appointment date and time from the database of available dates and times associated with the particular service provider.

### BRIEF DESCRIPTION OF THE DRAWINGS

A preferred embodiment of the present invention will now be described in detail with reference to the accompanying drawings, wherein:

FIG. 1 is a diagram showing a basic system architecture usable with the present invention.

FIG. 2 is a diagram showing an intermediate system architecture usable with the present invention.

FIG. 3 is a diagram showing a more complex system architecture usable with the present invention.

FIG. 4 is a diagram showing entity relationships between various databases of the present invention.

FIG. 5 is a diagram showing additional detail of the databases of FIG. 4.

FIG. 6 is a diagram showing additional detail of the databases of FIG. 4.

FIG. 7 is a diagram showing additional detail of the databases of FIG. 4.

FIG. 8 is a schematic flow diagram showing computer screens and information presented thereon available to a client in the present invention.

FIG. 9 is a schematic flow diagram showing computer screens and information presented thereon available to a service provider in the present invention.

FIG. 10 is a flow chart showing a method of the present invention.

FIG. 11 is an example starting web page for use with the method of FIG. 10.

Table 1, consisting of two (2) pages, lists the functionality and screen views available to users of the present invention.

Table 2, consisting of eleven (11) pages, lists the data fields and content therein used by the various databases of the present invention.

### DESCRIPTION OF A PREFERRED EMBODIMENT

The present invention describes a computerized method and system for enabling a client to access a service provider's appointment calendar to reserve available appointment times. Preferably, the system and method of the present invention are used for service providers that schedule appointments for discrete or standardized intervals of time, such as doctor appointments, hair cut appointments, and the like. In a preferred embodiment, the system of the present invention is operated by a third party intermediary on behalf of numerous clients and numerous service providers; however, the system can also be operated directly by a single service provider and made available to numerous clients of that particular service provider.

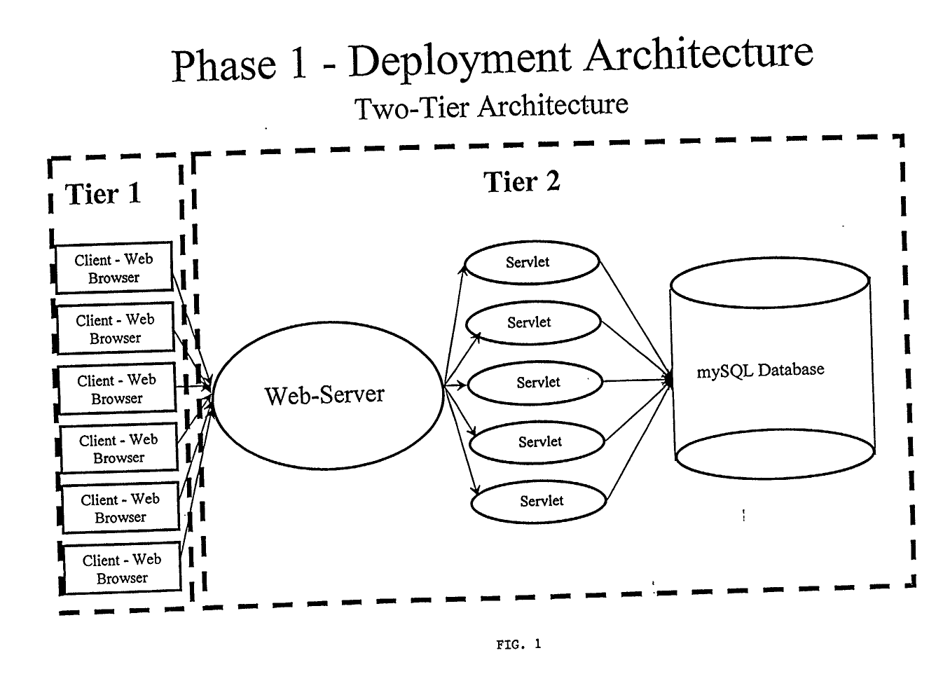

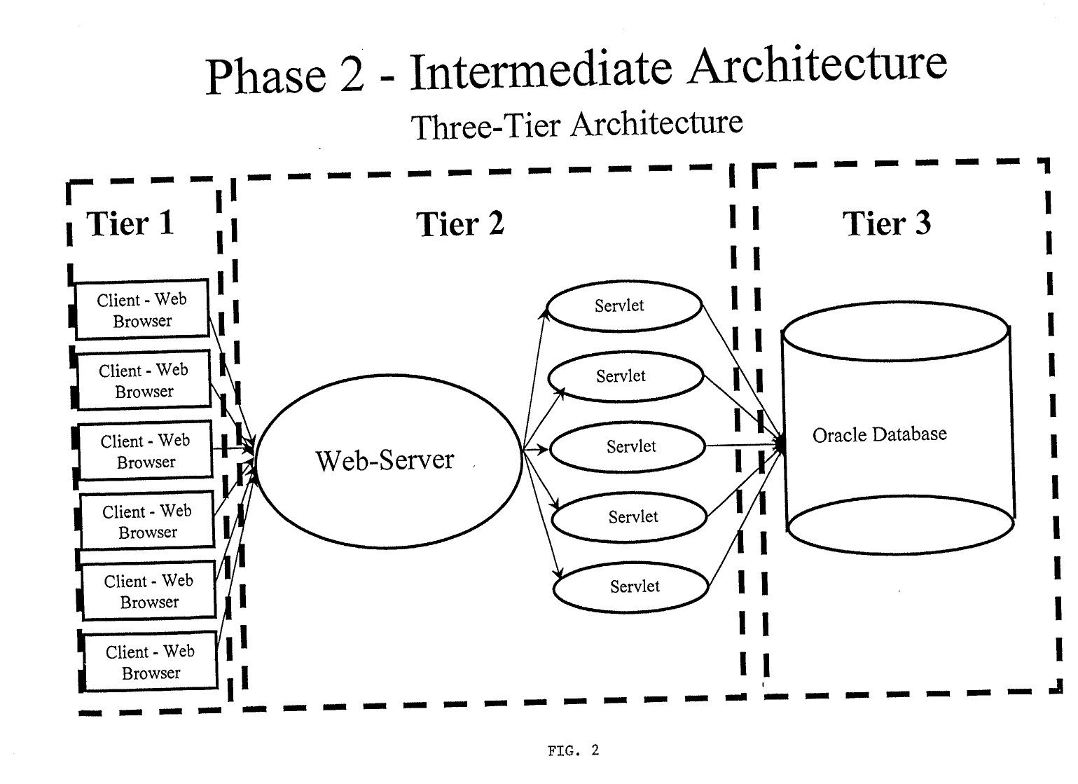

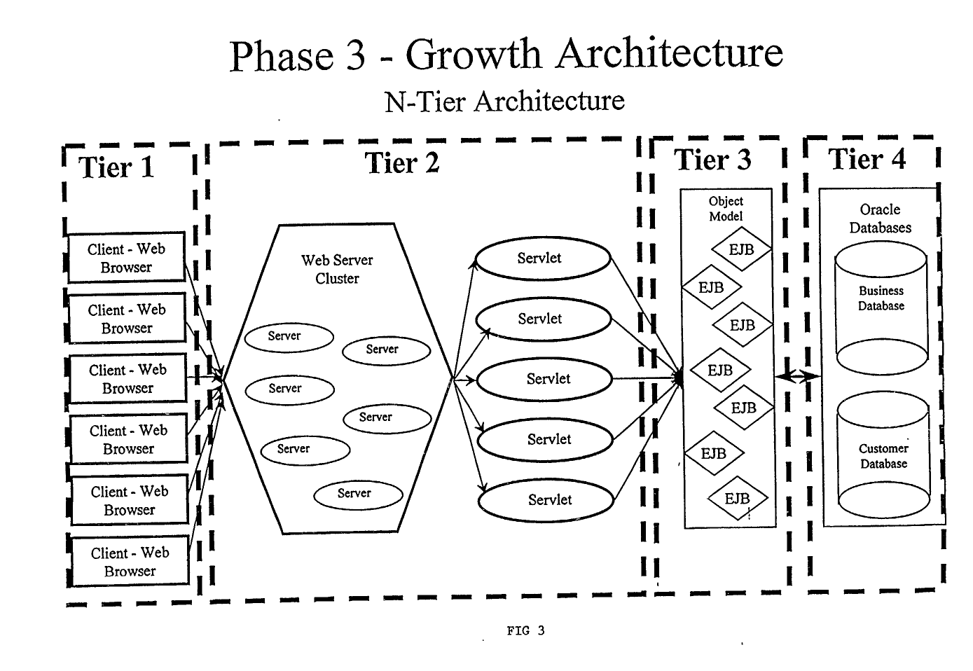

Turning now to the drawings, FIGS. 1-3 merely provide three different examples of system architecture platforms that could be used for the system and method of the present invention.

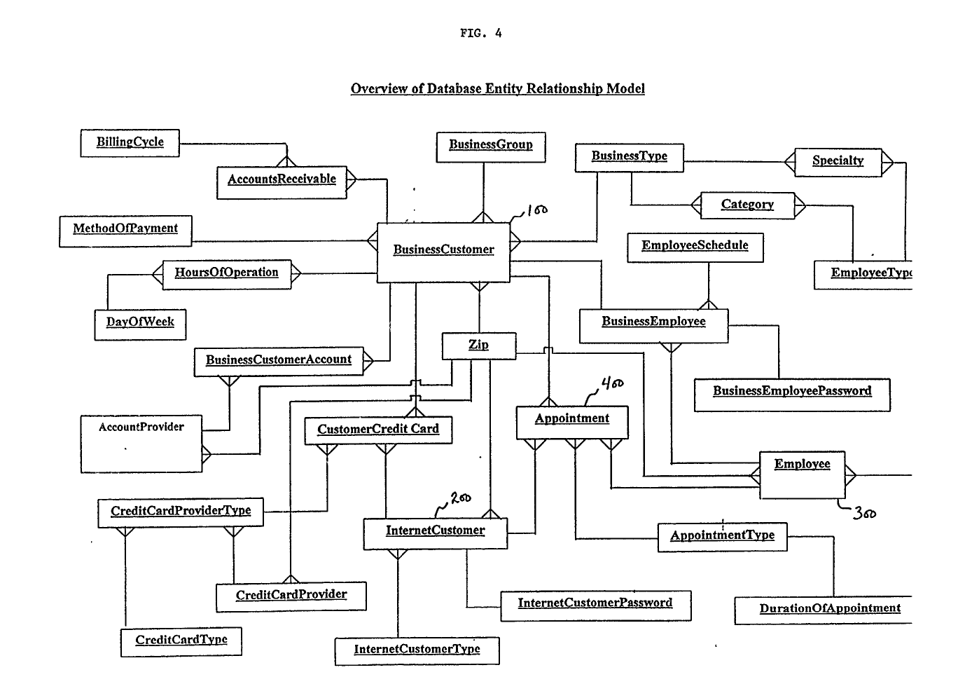

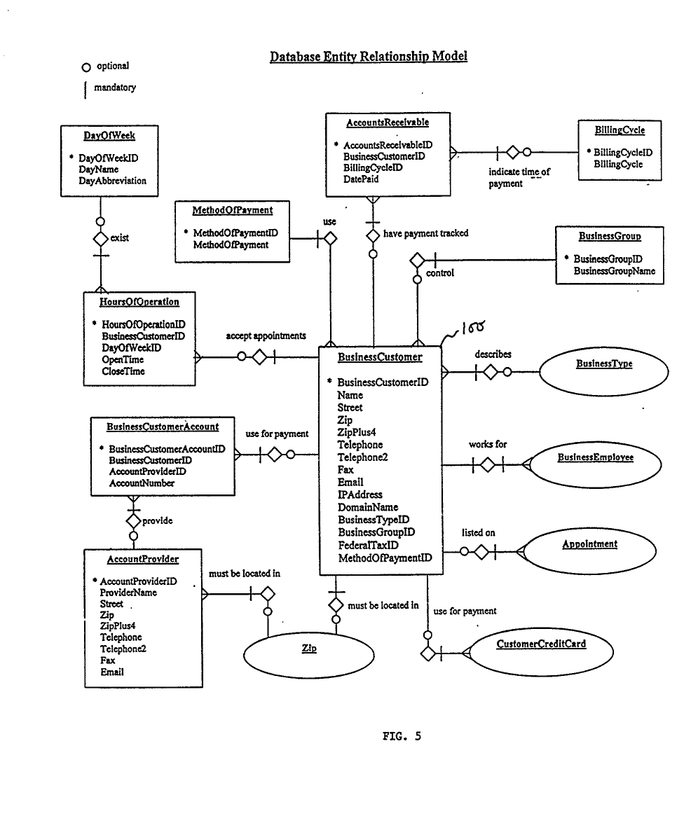

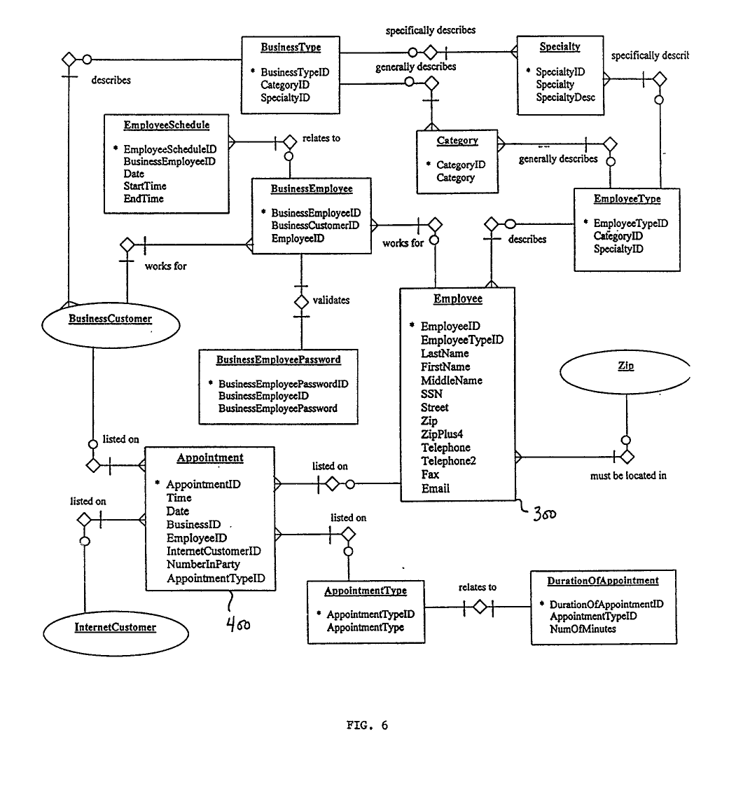

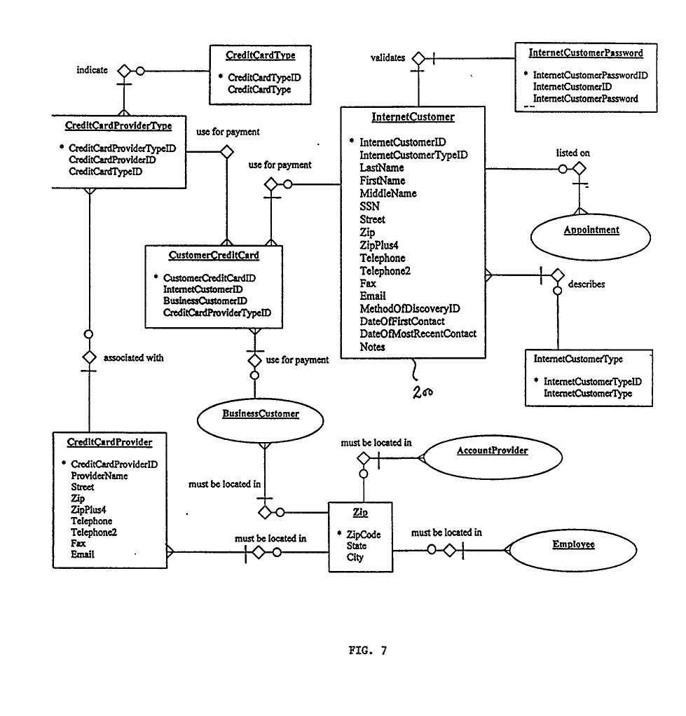

FIGS. 4 through 7 describe the relationships between the various databases used to implement the system and method of the present invention. More specifically, FIG. 4 provides a general overview of the preferred databases that are used by the present invention, and FIGS. 5-7 provide more detailed information about the type of data stored within each database. For example, as shown in FIG. 4, the BusinessCustomer database 100 identifies each service provider that is participating within the system of the present invention. The specific type of data actually stored in the BusinessCustomer database 100, such as relevant contact information about the service provider, is shown in more detail in FIG. 5 and in Table 2. Similarly, as shown in FIG. 4, the InternetCustomer database 200 identifies each client who has registered and is participating within the system of the present invention. The specific type of data actually stored in the InternetCustomer database 200, such as relevant contact information about the client, is shown in more detail in FIG. 7 and in Table 2. Similar information regarding employees of each service provider, who are authorized to view and/or edit the master appointment schedule, is shown in the Employee database 300 of FIGS. 4 and 6 and in Table 2. Similar information about any single appointment is stored in the Appointment database 400 as shown in FIGS. 4 and 6 and in Table 2. Although not described in detail, the remaining databases, their content, and their interaction with other databases is shown in FIGS. 4 through 7 and in Table 2.

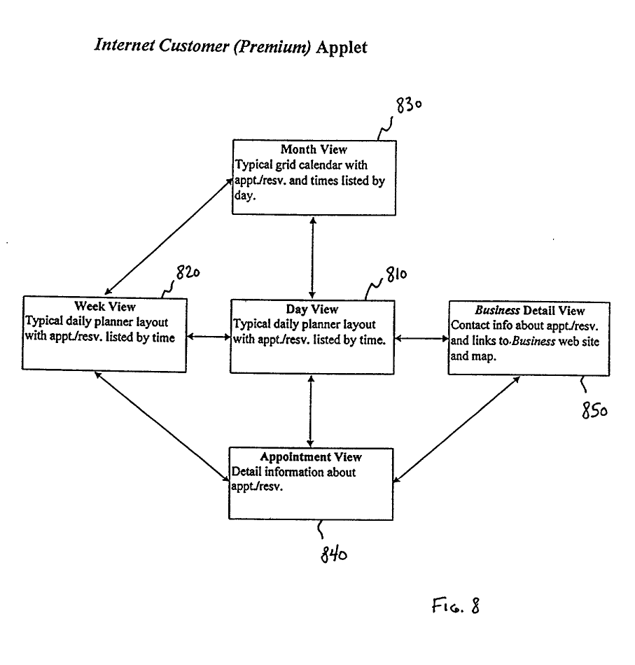

FIG. 8 shows the various types of screen displays that a client could view after selecting a particular service provider and when accessing the system of the present invention. Such screen displays could be generated by a Web browser accessing the web server of the system operator in known manner. The various screen displays include a Day View 810, a Week View 820, or a Month View 830. Additionally, the client could access a specific Appointment View screen display 840 to view any appointments that the client had entered for that particular service provider. Finally, the client could view a Business Detail View screen display 850, upon which or from which the client could obtain contact information about the particular service provider selected, including links to the service provider's website, if available, and a map to the service provider's location. It should also be understood that the screen displays shown in 810, 820, and 830 could be modified to show all appointments common to the client but involving different service providers. In such a case, selecting a particular appointment from one of these screens would enable the client to go to the Appointment View 830 or Business Detail View 850 for the selected appointment.

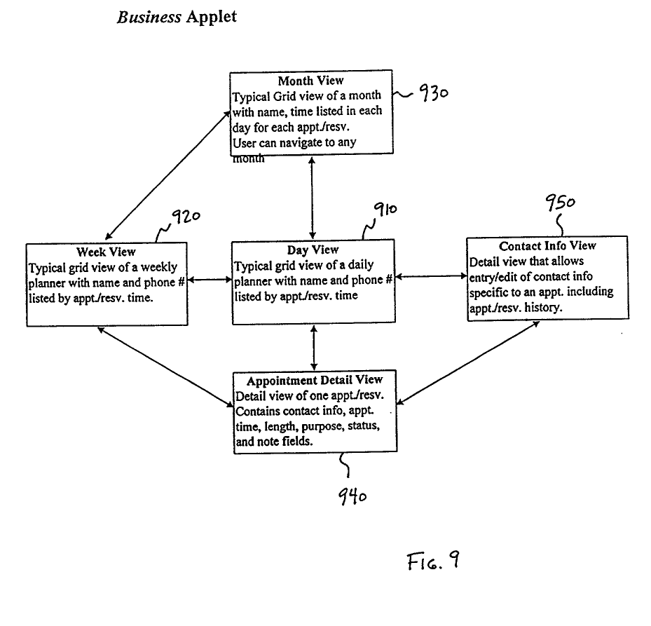

FIG. 9 shows the various types of screen displays that an authorized agent of a service provider could view when accessing the system of the present invention. Such screen displays could be generated by a Web browser accessing the web server of the system operator in known manner. The various screen displays include a Day View 910, a Week View 920, or a Month View 930. In contrast with the screen displays presented to a client, the service provider would have access to all of the appointments, with name and phone number of each client, for the given day, week, and month. Additionally, the agent of the service provider could access a specific Appointment Detail View screen display 940 to view additional information about any specific appointment scheduled or reserved by a client. The service provider could view information, such as purpose and status of the appointment, and would be able to add notes if desired for association with that particular client. Further, the service provider would have access to a Contact Info View screen display 950, from which the service provider could obtain historical information about the particular client's appointment/reservation history with the service provider. The service provider would be given authority to modify the dates and times of availability for appointments and would also have the ability to delete specific appointments, with the client receiving an email notification of the cancellation, with or without additional comments by the service provider.

Other information regarding the functionality of the system and preferred screen displays available to registered service providers, registered clients, and unregistered clients is set forth in Table 1.

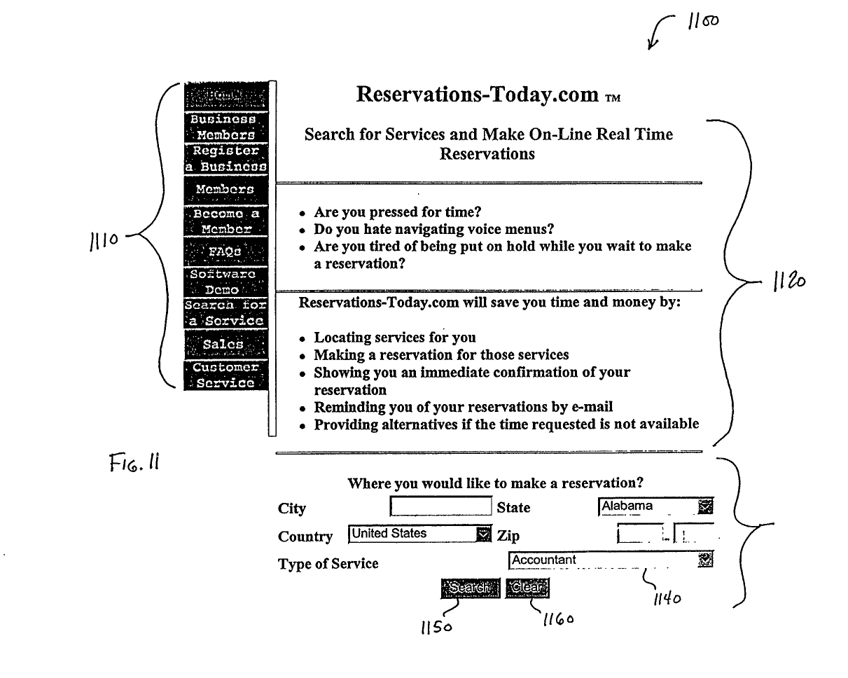

FIG. 11 shows one preferred screen display 1100 that could typically be presented to either a registered or unregistered client who is interested in finding a particular type of service provider in a particular geographic region. The example screen display 1100 includes a typical navigation bar 1110 with hotlinks to other web pages within the system. Optionally, the screen display can also include textual information 1120. A search criteria section 1130 of the screen display include blanks or pull-down menus for inserting the city, state, country, and zip code of the service provider for which the client is searching. In addition, the search criteria section 1130 includes a pull down menu 1140 for selecting the type of service provider for which the client seeks. Once all of the criteria have been selected, the client can search the database for available and registered service providers by selecting the search button 1150. The client can also clear all of the search criteria fields by selcting the clear button 1160.

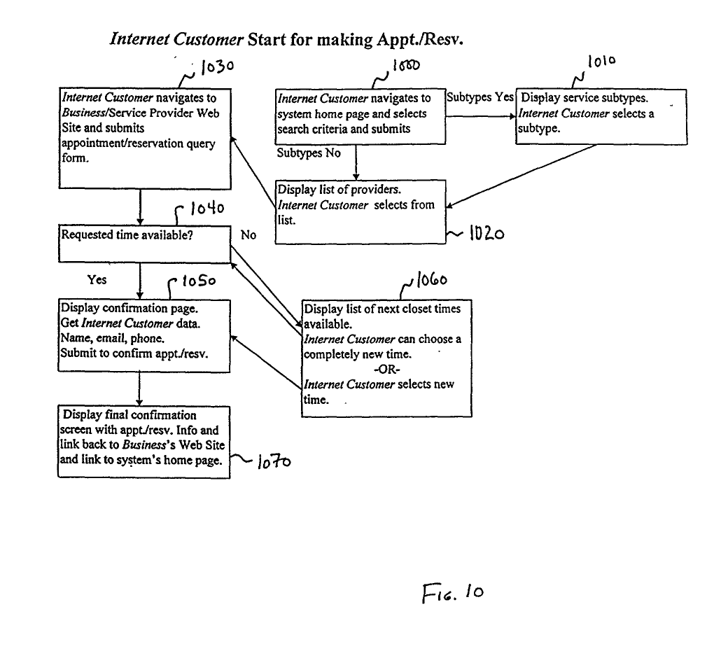

Referring back to FIG. 10, a method of the present invention is shown. A client initiates the method by navigating to a search criteria input screen display, such as that shown in FIG. 11, inputting search criteria, and then requesting the search using that criteria 1000. The system server processes the search request by accessing the BusinessCustomer database and determining which service providers satisfy the criteria. If the service providers found are not divided into subcategories or subtypes, the client is presented 1020 with a list of service providers that satisfy the search criteria. If the service providers found are divided in to subcategories or subtypes, a follow-up display and search criteria is presented 1010 to the client. In this case, the client can then select a subtype before being presented 1020 with the list of service providers that satisfy the further-modified search criteria. From this screen, the client then selects a particular service provider from the list of those available. The client is then presented 1030 with an appointment/reservation query form for the selected service provider. On this form, the client can merely request the ideal time and date when the client would like to make an appointment. When the requested time is submitted 1040, the system server accesses the appointment database for the particular service provider to determine if the requested date and time is available. If the time is available, the client is presented 1050 with a confirmation of the appointment. If the client had not already registered with the system, the client would be required to do so in order for the confirmation to be accepted. If the requested date and time from step 1030 is not available, the client is presented 1060 with a number of options. Specifically, the client is presented with a list of available times that are close to the requested date and time. For example, the system will present other available times for that same day that are available, for the same day of the week and same time originally requested but for a different week, etc. Additionally, the client has the option of entering a new date and time to be searched. If the client selects one of the offered and available appointment times, the client proceeds 1050 to the confirmation of the appointment. If the client selects a new date and time, the server reruns the search and determines 1040 whether the new appointment time is available.

While the present invention is intended to be practiced using computers, no specific software or logic circuit is intended nor is required to be used in the practicing of the present invention. Indeed, it would be a matter of routine skill to select an appropriate conventional computer system and implement the claimed process on that computer system. Accordingly, it is intended that any “means for” claims set forth herein encompass any computer embodiment of the corresponding method claims.

It will therefore be readily understood by those persons skilled in the art that the present invention is susceptible of broad utility and application. Many embodiments and adaptations of the present invention other than those herein described, as well as many variations, modifications and equivalent arrangements will be apparent from or reasonably suggested by the present invention and the foregoing description thereof, without departing from the substance or scope of the present invention. Accordingly, while the present invention has been described herein in detail in relation to its preferred embodiment, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements, the present invention being limited only by the claims appended hereto and the equivalents thereof.

TABLE 1
I. List of Requirements

| 1. | Business - Paid subscription service | | |
|---|---|---|---|
| | 1.1. | Functions | |
| | | 1.1.1. | HTML Link on Business Web Site to make an |
| | | | appointment |
| | | 1.1.2. | Retrieve Internet Customer scheduled |
| | | | appointments |
| | | 1.1.3. | Enter/edit/delete an appointment |
| | | 1.1.4. | Navigate through days, months, years with |
| | | | ease |
| | | 1.1.5. | Generate reports |
| | | 1.1.6. | Allow multiple concurrent users |
| | | 1.1.7. | Accessible from multiple locations |
| | | 1.1.8. | Platform Independent |
| | | 1.1.9. | Graphical view of appointments |
| | | 1.1.10. | Enter/edit/delete contact information |
| | | 1.1.11. | Client appointment reminders via email, |
| | | | pager, fax |
| | | 1.1.12. | Historical view of appointments by client |
| | | 1.1.13. | Fully customizable day start/end times |
| | | 1.1.14. | Multiple open/close times |
| | 1.2. | Views | |
| | | 1.2.1. | Week View |
| | | 1.2.2. | Month View |
| | | 1.2.3. | Day View |
| | | 1.2.4. | Appointment View |
| | | 1.2.5. | Contact Info View |
| | 1.3. | System Constraints | |
| | | 1.3.1. | Implemented as browser delivered Java |
| | | | Applet of less than 100k |
| | | 1.3.2. | Allowable data size per view is 10k or |
| | | | less |
| | | 1.3.3. | 2-3 second average combined data |
| | | | retrieval and view rendering time |
| 2. | Internet Customer Basic - Free Service | | |
| | 2.1. | Functions | |
| | | 2.1.1. | Make an appointment from a Business Web |
| | | | Site |
| | | 2.1.2. | Search for a particular Business or |
| | | | service in user's area from system's |
| | | | homepage |
| | | 2.1.3. | Retrieve a map of directions to |
| | | | appointment |
| | | 2.1.4. | Retrieve list of appointments |
| | | 2.1.5. | Retrieve list of service providers |
| | | | indicating which subscribe to system |
| | 2.2. | Views | |
| | | 2.2.1. | Form to request an appointment/reservation |
| | | | from Business's Web Site |
| | | 2.2.2. | Appointment/reservation available form to |
| | | | make an appointment/reservation |
| | | 2.2.3. | Appointment/reservation time not available - |
| | | | alternate times available list |
| | | 2.2.4. | Confirmation screen |
| | | 2.2.5. | Search for Business or service provider by |
| | | | area |
| | | 2.2.6. | List of secondary service types |
| | | 2.2.7. | List of Service providers indicating which |
| | | | subscribe to system |
| | | 2.2.8. | List of appointments currently made and |
| | | | confirmed by system |
| | 2.3. | Constraints | |
| | | 2.3.1. | Implemented in HTML/JavaScript only |
| | | 2.3.2. | Must support ALL Web Browsers including |
| | | | Web TV |
| 3. | Internet Customer Premium - Free Service with Registration | | |
| | 3.1. | Functions | |
| | | 3.1.1. | Make an appointment from a Business Web |
| | | | Site |
| | | 3.1.2. | Search for a particular Business or |
| | | | service in user's area from system's |
| | | | homepage |
| | | 3.1.3. | Retrieve a map of directions to appointment |
| | | 3.1.4. | Retrieve list of appointments |
| | | 3.1.5. | Retrieve list of service providers |
| | | | indicating which subscribe to system |
| | | 3.1.6. | Enter/edit/delete an appointment |
| | | 3.1.7. | Navigate through days, months, years with |
| | | | ease |
| | | 3.1.8. | Accessible from multiple locations |
| | | 3.1.9. | Platform Independent |
| | | 3.1.10. | Graphical view of appointments |
| | | 3.1.11. | Enter/edit/delete Business contact |
| | | | information |
| | | 3.1.12. | Request appointment reminders via email, |
| | | | pager, fax |
| | 3.2. | Views | |
| | | 3.2.1. | Form to request an appointment/reservation |
| | | | from Business's Web Site |
| | | 3.2.2. | Appointment/reservation available form to |
| | | | make an appointment/reservation |
| | | 3.2.3. | Appointment/reservation time not available - |
| | | | alternate times available list |
| | | 3.2.4. | Confirmation screen |
| | | 3.2.5. | Search for Business or service provider by |
| | | | area |
| | | 3.2.6. | List of secondary service types |
| | | 3.2.7. | List of Service providers indicating which |
| | | | subscribe to system |
| | | 3.2.8. | Week View |
| | | 3.2.9. | Month View |
| | | 3.2.10. | Day View |
| | | 3.2.11. | Appointment View |
| | | 3.2.12. | Business Contact Info View |
| | 3.3. | Constraints | |
| | | 3.3.1. | Implemented as browser delivered Java |
| | | | Applet of less than 75k |
| | | 3.3.2. | Allowable data size per view is 5k or less |
| | | 3.3.3. | 2-3 second average combined data retrieval |
| | | | and rendering time |

TABLE 2
Data Dictionary

BusinessCustomer - Table - contains information about the business
that is using the application to make andmaintain their appointments
BusinessCustomerID - integer(10) - primary key for BusinessCustomer Table
Name - alphanumeric(50) - name of BusinessCustomer
Street - alphanumeric(50) - street on which the business is located
Zip - integer(5) - foreign key to ZipCode Table - zip code of BusinessCustomer
ZipPlus4 - integer(10) - extended zip code of BusinessCustomer
Telephone - integer(10) - telephone number of BusinessCustomer
Telephone2 - integer(10) - second telephone number of BusinessCustomer
Fax - integer(10) - fax number of BusinessCustomer
Email - alphanumeric(50) - email address of BusinessCustomer
IP Address - alphanumeric(9) - IP address of BusinessCustomer
DomainName - alphanumeric(25) - domain name of BusinessCustomer
BusinessTypeID - integer(10) - foreign key to BusinessType Table
BusinessGroupID - integer(10) - foreign key to BusinessGroup Table
FederalTaxID - alphanumeric(9) - federal tax ID of the BusinessCustomer
BillingCycleID - integer(10) - foreign key to BillingCycle Table
MethodOfPaymentID - integer(10) - foreign key to MethodOfPayment Table
Employee - Table - contains information about the employees associated
with the businesses using the application
EmployeeID - integer(10) - primary key for Employee Table
EmployeeTypeID - integer(10) - foreign key to EmployeeType Table
LastName - alphanumeric(25) - last name of employee
FirstName - alphanumeric(25) - first name of employee
MiddleName - alphanumeric(25) - middle name of employee
SSN - alphanumeric(9) - social security number of employee
Street - alphanumeric(50) - street on which employee lives
Zip - integer(5) - foreign key to ZipCode Table - zip code of employee
ZipPlus4 - integer(10) - extended zip code of employee
Telephone - integer(10) - telephone number of employee
Telephone2 - integer(10) - second telephone number of employee
Fax - integer(10) - fax number of business
Email - alphanumeric(50) - email address of employee
Appointment - Table - contains information about an appointment
AppointmentID - integer(10) - primary key for Appointment Table
Time - time(6) - time of appointment
Date - date(8) - date of appointment
BusinessID - integer(10) - foreign key to Business Table
EmployeeID - integer(10) - foreign key to Employee Table
InternetCustomerID - integer(10) - foreign key to InternetCustomer Table
NumberInParty - integer(3) - how many individuals the appointment is scheduled for
AppointmentTypeID - integer(10) - foreign key to AppointmentType Table
InternetCustomer - Table - contains information about the general user - fields required for a general user
will vary depending on whether or not they are a member of the application's website or not
InternetCustomerID - integer(10) - primary key for InternetCustomer Table
InternetCustomerTypeID - integer(10) - foreign key for InternetCustomerType Table
LastName - alphanumeric(25) - last name of internet customer
FirstName - alphanumeric(25) - first name of internet customer
MiddleName - alphanumeric(25) - middle name of internet customer
SSN - alphanumeric(9) - social security number of internet customer
Street - alphanumeric(50) - street on which internet customer lives
Zip - integer(5) - foreign key to ZipCode Table - zip code of internet customer
ZipPlus4 - integer(10) - extended zip code of internet customer
Telephone - integer(10) - telephone number of internet customer
Telephone2 - integer(10) - second telephone number of internet customer
Fax - integer(10) - fax number of internet customer
Email - alphanumeric(50) - email address of internet customer
MethodOfDiscoveryID - integer(10) - foreign key to MethodOfDiscovery Table
DateOfFirstContact - date(8) - date that the internet customer first used this site to schedule an appointment
DateOfMostRecentContact - date(8) - the most recent date that the internet
customer used this site to schedule an appointment
Notes - alphanumeric(200) - notes or comments about the internet customer
BusinessGroup - Table - contains information about the owner/owners
of the business customer
BusinessGroupID - integer(10) - primary key for BusinessGroup Table
BusinessGroupName - alphanumeric(50) - name of the individual, group, or company that owns the business
BusinessEmployee - Table - join table between the BusinessCustomer and Employee Tables - an employee
may work at more than one business (physicians working in several clinics, etc)
BusinessEmployeeID - integer(10) - primary key for BusinessEmployee Table
BusinessCustomerID - integer(10) - foreign key for BusinessCustomer Table
EmployeeID - integer(10) - foreign key for Employee Table
Category - Table - contains a list of possible business and employee categories
CategoryID - integer(10) - primary key for Category Table
Category - alphanumeric(25) - general description of business/employee (Restaurant, Physician, etc)
Specialty - Table - contains a list of possible business and employee specialties
SpecialtyID - integer(10) - primary key for Specialty Table
Specialty - alphanumeric(25) - specific description of business/employee (Muffler Shop, Podiatrist, etc)
SpecialtyDesc - alphanumeric(100) - detailed description of the specialty (A Podiatrist deals with problems
associated with the feet)
BusinessType - Table - lists the category and all specialties associated with a business customer
BusinessTypeID - integer(10) - primary key for BusinessType Table
BusinessCustomerID - integer(10) - foreign key for BusinessCustomer Table
CategoryID - integer(10) - foreign key for Category Table
SpecialtyID - integer(10) - foreign key for Specialty Table
EmployeeType - Table - lists the category and all specialties associated with an employee
EmployeeTypeID - integer(10) - primary key for EmployeeType Table
EmployeeID - integer(10) - foreign key for Employee Table
CategoryID - integer(10) - foreign key for EmployeeCategory Table
SpecialtyID - integer(10) - foreign key for EmployeeSpecialty Table
BusinessEmployeePassword - Table - contains the password of employees - depending on the employee's
type (Manager, etc), the employee will be allowed to access various business features of the application
BusinessEmployeePasswordID - integer(10) - primary key for BusinessEmployeePasswordID Table
BusinessEmployeeID - integer(10) - foreign key for BusinessEmployee Table
BusinessEmployeePassword - alphanumeric(8) - employee's password
InternetCustomerType - Table - list of possible internet customer types
InternetCustomerTypeID - integer(10) - primary key for InternetCustomerType Table
InternetCustomerType - alphanumeric(25) - description of the type of user (member or non-member)
InternetCustomerPassword - Table - contains the password of internet customers - depending on the internet
customer's type (member, etc), the internet customer will be allowed access to various features of the
application
InternetCustomerPasswordID - integer(10) - primary key for InternetCustomerPassword Table
InternetCustomerID - integer(10) - foreign key for InternetCustomer Table
InternetCustomerPassword - alphanumeric(8) - internet customer's password
CreditCardType - Table - list of possible types of credit cards
CreditCardTypeID - integer(10) - primary key for the CreditCardType Table
CreditCardType - alphanumeric(15) - type of credit card (VISA, MC, etc)
CustomerCreditCard - Table - this table links business and internet
customers with their credit card information
CustomerCreditCardID - integer(10) - primary key for InternetCustomerCreditCard Table
InternetCustomerID - integer(10) - foreign key for InternetCustomer Table
BusinessCustomerID - integer(10) - foreign key for BusinessCustomer Table
CreditCardProviderTypeID - integer(10) - foreign key for CreditCardProviderType Table
CreditCardProvider - Table - contains information about all of the various institutions which provide credit
cards to the business and internet customers using this application
CreditCardProviderID - integer(10) - primary key for CreditCardProvider Table
ProviderName - alphanumeric(25) - name of the company that is providing the credit card
Street - alphanumeric(50) - street on which provier is located
Zip - integer(5) - foreign key to zip code table - zip code of the provider
ZipPlus4 - integer(10) - extended zip code of the provider
Telephone - integer(10) - telephone number of the provider
Telephone2 - integer(10) - second telephone number of the provider
Fax - integer(10) - fax number of the provider
Email - alphanumeric(50) - email address of the provider
CreditCardProviderTypeID - integer(10) - foreign key for the CreditCardProviderType Table
CreditCardProviderType - Table - links the credit card providers with the types of credit cards they offer
(only contains the kinds of cards that business/internet customers using this application possess)
CreditCardProviderTypeID - integer(10) - primary key for the CreditCardProviderType Table
CreditCardProviderID - integer(10) - foreign key for the CreditCardProvider Table
CreditCardTypeID - integer(10) - foreign key for the CreditCardType Table
EmployeeSchedule - Table - contains the general work schedule of the employee (9-5 on Dec. 12, 1999)
EmployeeScheduleID - integer(10) - primary key for EmployeeSchedule Table
BusinessEmployeeID - integer(10) - foreign key for BusinessEmployee Table
Date - date(8) - month, day, and year that the start and end time correspond to
StartTime - time(6) - start time of the employee's schedule
EndTime - time(6) - end time of the employee's schedule
DayOfWeek - Table - contains the days of the week and their abbreviations
DayOfWeekID - integer(02) - primary key for DayOfWeek Table
DayName - alphanumeric(9) - day of the week (Monday, Tuesday, etc)
DayAbbreviation - alphanumeric(5) - abbreviation of the day of the week (Mon, Tues, etc)
HoursOfOperation - Table - contains the range of times when appointments
may be made for each business, based on the day of the week
HoursOfOperationID - integer(10) - primary key for HoursOfOperation Table
BusinessCustomerID - integer(10) - foreign key for BusinessCustomer Table
DayOfWeekID - integer(02) - foreign key for DayOfWeek Table
OpenTime - time(6) - time business begins taking appointments
CloseTime - time(6) - time business stops taking appointments
AppointmentType - Table - list of all possible types of appointments
AppointmentTypeID - integer(10) - primary key for AppointmentType Table
AppointmentType - alphanumeric(25) - brief description of the appointment (hair cut, oil change, etc)
DurationOfAppointment - Table - contains the length of time that a specific type of appointment will take for
a particular business customer (Hair Cuts 'R Us, perm, 60 minutes)
DurationOfAppointmentID - integer(10) - primary key for DurationOfAppointment Table
BusinessCustomerID - integer(10) - foreign key for BusinessCustomer Table
AppointmentTypeID - integer(10) - foreign key for AppointmentType Table
NumOfMinutes - integer(4) - number of minutes to complete a specific type of appointment
MethodOfPayment - Table - lists all possible types of payment options
for business use of the application
MethodOfPaymentID - integer(10) - primary key for MethodOfPayment Table
MethodOfPayment - alphanumeric(20) - type of payment used by business customer to pay for use and
maintenance of application (credit card, automatic withdrawal, etc)
BusinessCustomerAccount - Table - contains account information
for business that choose a method ofpayment other than credit card
BusinessCustomerAccountID - integer(10) - primary key for BusinessCustomerAccount Table
BusinessCustomerID - integer(10) - foreign key to BusinessCustomer Table
AccountProviderID - integer(10) - foreign key to AccountProvider Table
AccountNumber - integer(15) - account number of account used to make payments for application
AccountProvider - Table - contains information about the institution
where the account used to pay for the application is held
AccountProviderID - integer(10) - primary key for AccountProvider Table
ProviderName - alphanumeric(25) - name of the company where the account is held
Street - alphanumeric(50) - street on which provider is located
Zip - integer(5) - foreign key to ZipCode Table - zip code of the provider
ZipPlus4 - integer(10) - extended zip code of the provider
Telephone - integer(10) - telephone number of the provider
Telephone2 - integer(10) - second telephone number of the provider
Fax - integer(10) - fax number of the provider
Email - alphanumeric(50) - email address of the provider
BillingCycle - Table - list of possible billing days
(1^{st} of month, 15^{th} of month, 30^{th} of month, etc)
BillingCycleID - integer(10) - primary key for BillingCycle Table
BillingCycle - integer(2) - numeric value indicating which day of the month the business will be billed for use
and maintenance of the application
AccountsReceivable - Table - contains the billing cycle for each
business and the date that the bill was paid
AccountsReceivableID - integer(10) - primary key for AccountsReceivable Table
BusinessCustomerID - integer(10) - foreign key for BusinessCustomerID Table
BillingCycleID - integer(10) - foreign key for BillingCycle Table
DatePaid - date(8) - the date that the payment is received

1. In a computerized system, a method of enabling a client to schedule an appointment with a particular service provider, comprising the steps of:
(a) providing a database of service providers, each service provider having associated therewith a plurality of identifying criteria;
(b) receiving from the client a search request having a plurality of desired criteria associated with the particular service provider;
(c) comparing the plurality of desired criteria with the plurality of identifying criteria for each service provider in the database of service providers;
(d) presenting the client with a list of service providers having associated therewith the desired criteria;
(e) enabling the client to select the particular service provider from the list of service providers presented;
(f) enabling the client to request a proposed appointment date and time for meeting with the particular service provider;
(g) comparing the proposed appointment date and time with a database of available dates and times associated with the particular service provider;
(h) obtaining identifying information from the client;
(i) converting the proposed appointment date and time to a confirmed appointment date and time;
(j) adding the confirmed appointment date and time to a database of appointments associated with the particular service provider; and
(k) removing the confirmed appointment date and time from the database of available dates and times associated with the particular service provider.

2. The method of claim 1 further comprising the step of providing the client with directions to the particular service provider.

3. The method of claim 1 further comprising the step of sending the client a reminder of the confirmed appointment date and time prior to the confirmed appointment date and time.

4. The method of claim 1 further comprising the step of, if the proposed appointment date and time for meeting with the particular service provider is not available, suggesting a different appointment date and time that is available in the database of available dates and times associated with the particular service provider.

5. The method of claim 1 further comprising the step of, if the proposed appointment date and time for meeting with the particular service provider is not available, enabling the client to request another proposed appointment date and time.

6. The method of claim 1 further comprising the step of enabling the client to define the search request by selecting each of the desired criteria from a database of available desired criteria.

7. The method of claim 1 further comprising the step of enabling the client to view information about the confirmed appointment date and time.

8. The method of claim 1 further comprising the step of enabling the client to view information about confirmed appointment dates and times for a plurality of particular service providers.

9. The method of claim 1 further comprising the step of enabling the particular service provider to view information about the confirmed appointment date and time.

10. The method of claim 1 further comprising the step of enabling the particular service provider to view information about confirmed appointment dates and times for a plurality of clients.

11. The method of claim 1 further comprising the steps of:
(a) enabling the client to cancel the confirmed appointment date and time;
(b) adding the confirmed appointment date and time to the database of available dates and times associated with the particular service provider; and
(c) removing the confirmed appointment date and time from the database of appointments associated with the particular service provider.

12. The method of claim 1 further comprising the steps of:
(a) enabling the particular service provider to cancel the confirmed appointment date and time;
(b) adding the confirmed appointment date and time to the database of available dates and times associated with the particular service provider; and
(c) removing the confirmed appointment date and time from the database of appointments associated with the particular service provider.

13. In a computerized system, a method of enabling a client to schedule an appointment with a particular service provider, comprising the steps of:
(a) providing a database of service providers, each service provider having associated therewith a plurality of identifying criteria;
(b) obtaining identifying information from the client;
(c) receiving from the client a search request having a plurality of desired criteria associated with the particular service provider;
(d) comparing the plurality of desired criteria with the plurality of identifying criteria for each service provider in the database of service providers;
(e) presenting the client with a list of service providers having associated therewith the desired criteria;
(f) enabling the client to select the particular service provider from the list of service providers presented;
(g) enabling the client to request a proposed appointment date and time for meeting with the particular service provider from a selection of available appointment dates and times from the database of available dates and times associated with the particular service provider;
(h) converting the proposed appointment date and time to a confirmed appointment date and time;
(i) adding the confirmed appointment date and time to a database of appointments associated with the particular service provider; and
(j) removing the confirmed appointment date and time from the database of available dates and times associated with the particular service provider.
